(19) United States
(12) Patent Application Publication
(10) Pub. No.: US 2024/0319500 A1
(43) Pub. Date: Sep. 26, 2024

(54) FACE COVER

(71) Applicant: Samsung Electronics Co., Ltd., Suwon-si (KR)

(72) Inventor: Jonggyu PARK, Suwon-si (KR)

(21) Appl. No.: 18/610,876

(22) Filed: Mar. 20, 2024

Related U.S. Application Data
(63) Continuation of application No. PCT/KR2024/003517, filed on Mar. 20, 2024.

(30) Foreign Application Priority Data
Mar. 20, 2023 (KR) 10-2023-0035784
May 26, 2023 (KR) 10-2023-0068691

(51) Int. Cl. G02B 27/01

(52) U.S. Cl. CPC G02B 27/0149; G02B 2027/0163; G02B 2027/0169

(57) ABSTRACT

A face cover detachably coupled to a head-mounted display apparatus that includes a lens and a lens barrel configured to surround the lens and adjust positions of the lens is provided. The face cover includes a housing including an opening formed in an area thereof, a lens adjustment member disposed in the opening so that at least a portion thereof is exposed through the opening, and an elastic member that includes opposite ends arranged in the housing and a central portion thereof coupled to the lens adjustment member, and is configured to provide an elastic force so as to allow the lens adjustment member to move in a first direction or in a second direction opposite to the first direction. In case that an external force is applied to the lens adjustment member in the first direction, the lens adjustment member is configured to be moved in the first direction such that the lens adjustment member come into contact with the lens barrel. And in case that the lens adjustment member rotates in a first rotation direction in a state where the lens adjustment member and the lens barrel is in contact with each other, the lens barrel is configured to rotate in a second rotation direction opposite to the first rotation direction such that a diopter of the lens is adjusted.

### CROSS-REFERENCE TO RELATED APPLICATION(S)

This application is a continuation application, claiming priority under § 365(c), of an International application No. PCT/KR2024/003517 filed on Mar. 20, 2024, which is based on and claims the benefit of a Korean patent application number 10-2023-0035784 filed on Mar. 20, 2023 in the Korean Intellectual Property Office, and of a Korean patent application number 10-2023-0068691 filed on May 26, 2023 in the Korean Intellectual Property Office, the disclosure of each of which is incorporated by reference herein in its entirety.

### TECHNICAL FIELD

The disclosure relates to a face cover.

### BACKGROUND ART

Due to remarkable developments in information communication and semiconductor technologies, the dissemination and utilization of various types of electronic devices are rapidly increasing. In particular, recent electronic devices have been developed to enable communication while being carried.

Electronic devices may mean devices that perform specific functions according to embedded programs, such as home appliances, electronic notes, portable multimedia players, mobile communication terminals, tablet personal computers (PCs), video/audio devices, desktop/laptop computers, or vehicle navigation systems. For example, such electronic devices may output stored information in the form of sound or images. According to the increasing integration of electronic devices and the common use of ultra-high-speed and large-volume wireless communication, in recent times, various functions can be embedded in a single electronic device such as a mobile communication terminal. For example, various functions such as an entertainment function such as gaming, a multimedia function such as music/video playback, a communication and a security function for mobile banking, and a function such as a schedule management or electronic wallet as well as a communication function have been integrated into a single electronic device. Such electronic devices are becoming more compact to be conveniently carriable by a user.

The above information is presented as background information only to assist with an understanding of the disclosure. No determination has been made, and no assertion is made, as to whether any of the above might be applicable as prior art with regard to the disclosure.

### DETAILED DESCRIPTION OF THE INVENTION

Aspects of the disclosure are to address at least the above-mentioned problems and/or disadvantages and to provide at least the advantages described below. Accordingly, an aspect of the disclosure is to provide a face cover.

Additional aspects will be set forth in part in the description which follows and, in part, will be apparent from the description, or may be learned by practice of the presented embodiments.

In accordance with an aspect of the disclosure, a face cover detachably coupled to a head-mounted display apparatus that includes a lens and a lens barrel configured to surround the lens and adjust positions of the lens is provided. The face cover includes a housing including an opening formed in an area thereof, a lens adjustment member disposed in the opening so that at least a portion thereof is exposed through the opening, and an elastic member that includes opposite ends fixed to the housing and a central portion thereof coupled to the lens adjustment member, and is configured to provide an elastic force so as to allow the lens adjustment member to move in a first direction or in a second direction opposite to the first direction. In case that an external force is applied to the lens adjustment member in the first direction, the lens adjustment member is configured to be moved in the first direction and such that come into contact with each of the lens barrels. And in case that the lens adjustment member rotates in a first rotation direction in a state where the lens adjustment member and the lens barrels are in contact with each other, the lens barrel is configured to rotate in a second rotation direction opposite to the first rotation direction such that a diopter of the lens is adjusted.

In accordance with another aspect of the disclosure, a head-mounted display apparatus is provided. The head-mounted display apparatus includes a lens, a lens barrel configured to surround the lens and be rotatable so as to adjust a position of the lens, and a body part detachably coupled to a face cover that includes a lens adjustment member configured to be in contact with a surface of the lens barrel, wherein based on the lens adjustment member of the face cover rotating in a first rotation direction, the lens barrel is configured to rotate in a second rotation direction opposite to the first rotation direction, and the lens is configured to move in a front direction or a rear direction of the head-mounted display apparatus.

In accordance with yet another aspect of the disclosure, a face cover detachably coupled to a head-mounted display apparatus is provided. The face cover includes a housing including an opening formed in an area thereof, a lens adjustment member disposed in the opening so that at least a portion thereof is exposed through the opening, and an elastic member that includes a central portion thereof coupled to the lens adjustment member, and is configured to provide an elastic force so as to allow the lens adjustment member to move in a first direction or in a second direction opposite to the first direction. In case that an external force is applied to the lens adjustment member in the first direction, the lens adjustment member is configured to be moved in the first direction. And in case that the lens adjustment member rotates in a first rotation direction, the lens adjustment member is configured to adjust a diopter of a lens of the head-mounted display apparatus.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a perspective view of a wearable electronic device according to an embodiment of the disclosure;

FIG. 3 is a combined perspective view for showing an internal configuration of a wearable electronic device according to an embodiment of the disclosure;

FIG. 4 is an exploded perspective view of a wearable electronic device according to an embodiment of the disclosure;

FIG. 5A is a view showing a face cover coupled to a head-mounted display apparatus according to an embodiment of the disclosure;

FIG. 5B is a view showing a cross section of a pair of lenses of a head-mounted display apparatus according to an embodiment of the disclosure;

FIGS. 6A and 6B are views showing a head-mounted display apparatus and a face cover according to various embodiments of the disclosure;

FIG. 7 is an exploded perspective view showing a face cover according to an embodiment of the disclosure;

FIGS. 8A, 8B, 8C, and 8D are views showing a lens adjustment member and an elastic member according to various embodiments of the disclosure;

FIGS. 9A, 9B, and 9C are views showing a process in which the diopter of lenses is adjusted according to various embodiments of the disclosure;

FIGS. 10A and 10B are views showing changes in the positions of a lens adjustment member and an elastic member according to various embodiments of the disclosure;

FIG. 11 is a cross-sectional view showing a combined state of a head-mounted display apparatus and a face cover, taken along line A-A′ in FIG. 9A according to an embodiment of the disclosure;

FIGS. 12A and 12B are views showing changes in the positions of a lens adjustment member 420 and an elastic member 430 according to the adjustment of distance between lenses according to various embodiments of the disclosure; and

FIG. 13 is a view showing diopter sensing members according to an embodiment of the disclosure.

The same reference numerals are used to represent the same elements throughout the drawings.

### MODE FOR CARRYING OUT THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

According to an embodiment, each component (e.g., a module or a program) of the above-described components may include a single entity or multiple entities, and some of the multiple entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

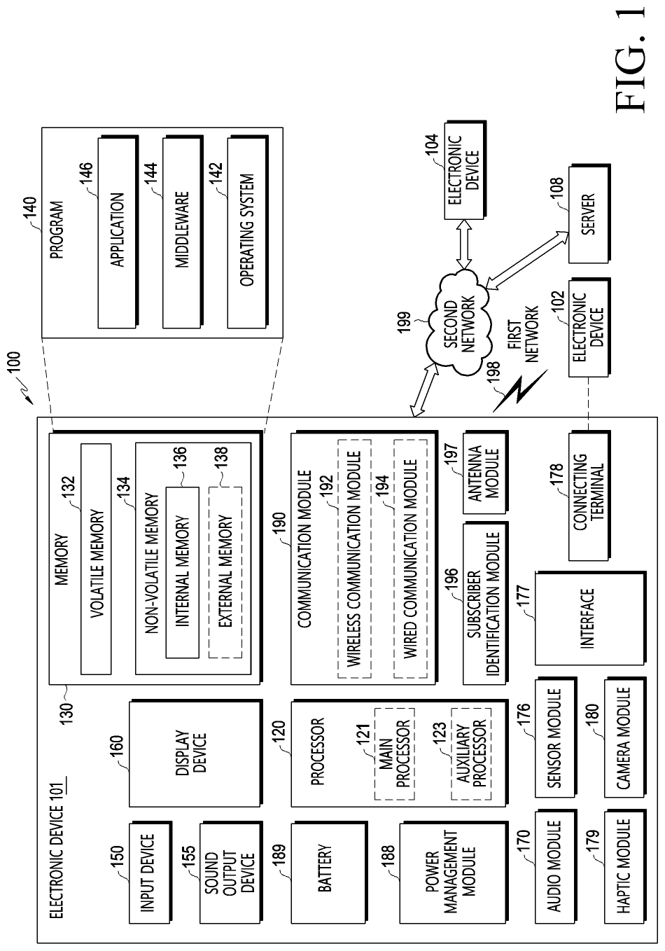

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display device 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134. The non-volatile memory 134 may include at least one of internal memory 136 or external memory 138.

The program 140 may be stored in the memory 130 as software, and may include, for example, an operating system (OS) 142, middleware 144, or an application 146.

The input device 150 may receive a command or data to be used by another component (e.g., the processor 120) of the electronic device 101, from the outside (e.g., a user) of the electronic device 101. The input device 150 may include, for example, a microphone, a mouse, a keyboard, a key (e.g., a button), or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth-generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth-generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter-wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to an embodiment, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

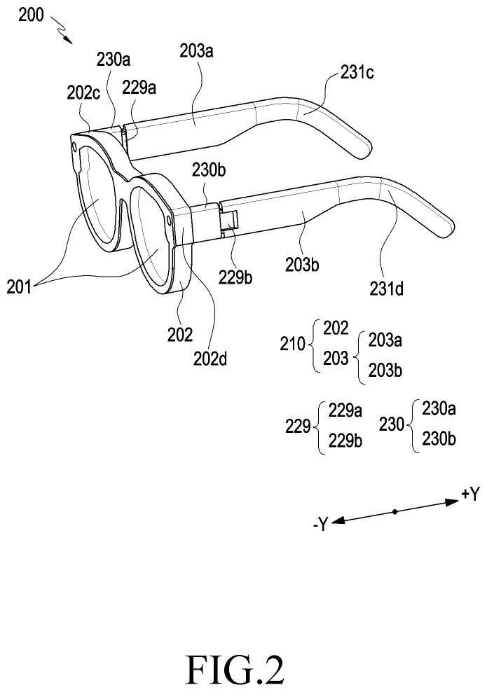

FIG. 2 is a perspective view of a wearable electronic device 200 according to an embodiment of the disclosure.

Referring to FIG. 2, a wearable electronic device 200 may be an electronic device (e.g., the electronic device 101 in FIG. 1) in the form of eyeglasses, and a user may visually recognize a surrounding object or environment in a state of wearing the wearable electronic device 200. For example, the wearable electronic device 200 may include a head mounting device (HMD) or a smart glasses capable of providing an image directly in front of the eyes of a user. The configuration of the wearable electronic device 200 in FIG. 2 may be partially or entirely the same as the configuration of the electronic device 101 in FIG. 1.

According to an embodiment, the wearable electronic device 200 may include a housing 210 for forming the exterior of the wearable electronic device 200. The housing 210 may provide a space in which components of the wearable electronic device 200 can be arranged. For example, the housing 210 may include a lens frame 202 and at least one wearable member 203.

According to an embodiment, the wearable electronic device 200 may include at least one display member 201 disposed in the housing 210 and capable of outputting a visual image. For example, the wearable electronic device 200 may include the at least one display member 201 capable of providing visual information (or image) to a user. For example, the display member 201 may include a module to which a lens, a display, a waveguide, and/or a touch circuit is mounted. According to an embodiment, the display member 201 may be formed to be transparent or translucent. According to an embodiment, the display member 201 may include a glass member made of a translucent material or a window member of which the light transmittance can be adjusted as the colored concentration thereof is adjusted.

According to an embodiment, the lens frame 202 may accommodate at least a part of the display member 201. For example, the lens frame 202 may surround at least a part of the edge of the display member 201. According to an embodiment, the lens frame 202 may allow the at least one display member 201 to be positioned to correspond to the eyes of a user. According to an embodiment, the lens frame 202 may be a rim having a general eyeglass structure. According to an embodiment, the lens frame 202 may include at least one closed curve for surrounding the display member 201. According to an embodiment, the lens frame 202 may include a first end 202c and a second end 202d opposite to the first end 202c. The first end 202c may be disposed adjacent to a first wearable member 203a, and the second end 202d may be disposed adjacent to a second wearable member 203b.

According to an embodiment, the wearable member 203 may extend from the lens frame 202. For example, the wearable member 203 may extend from the end of the lens frame 202, and may be supported or positioned on the body (e.g., ears) of a user together with the lens frame 202. According to an embodiment, the wearable member 203 may be rotatably coupled with respect to the lens frame 202 through a hinge structure 229. According to an embodiment, the wearable member 203 may include an inner surface 231c configured to face the body of a user and an outer surface 231d opposite to the inner surface 231c. According to an embodiment (not shown), at least a part of the wearable member 203 may be formed of a flexible material (e.g., rubber). For example, at least a part of the wearable member 203 may be formed in a band shape for surrounding at least a part of the body (e.g., ears) of a user.

According to an embodiment, the wearable electronic device 200 may include the hinge structure 229 configured to allow the wearable member 203 to be folded with respect to the lens frame 202. The hinge structure 229 may be disposed between the lens frame 202 and the wearable member 203. In a state where a user does not wear the wearable electronic device 200, the wearable member 203, by a user, may be folded to partially overlap the lens frame 202, and thus the wearable electronic device may be carried or stored. According to an embodiment, the hinge structure 229 may include a first hinge structure 229a connected to a part (e.g., the first end 202c) of the lens frame 202 and the first wearable member 203a, and a second hinge structure 229b connected to a part (e.g., the second end 202d) of the lens frame 202 and the second wearable member 203b.

According to an embodiment, the first hinge structure 229a and the second hinge structure 229b may be arranged to be spaced apart from the display member 201 by a predetermined distance in the Y-axis direction. A hinge connection structure 230 may include a first hinge connection structure 230a and a second hinge connection structure 230b. The first hinge structure 229a may be fixed to the lens frame 202 by the first hinge connection structure 230a, and the second hinge structure 229b is fixed to the lens frame 202 by the second hinge connection structure 230b.

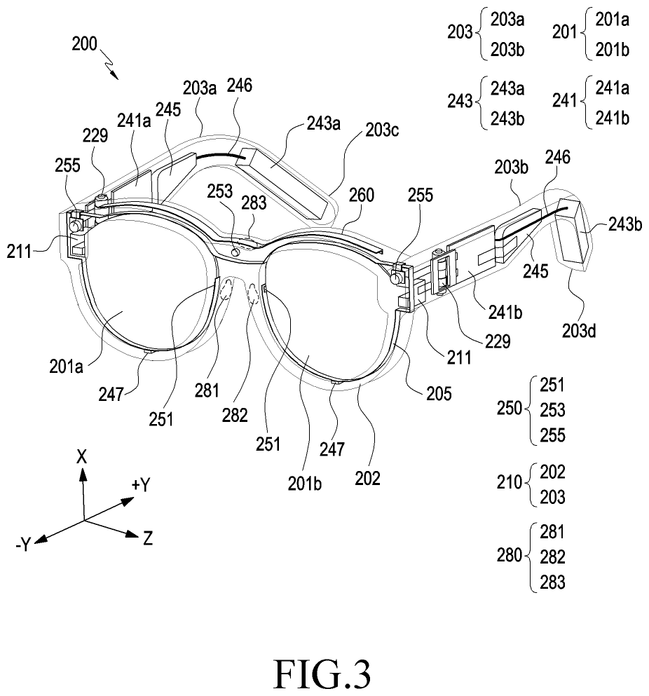

FIG. 3 is a combined perspective view for showing an internal configuration of a wearable electronic device 200 according to an embodiment of the disclosure.

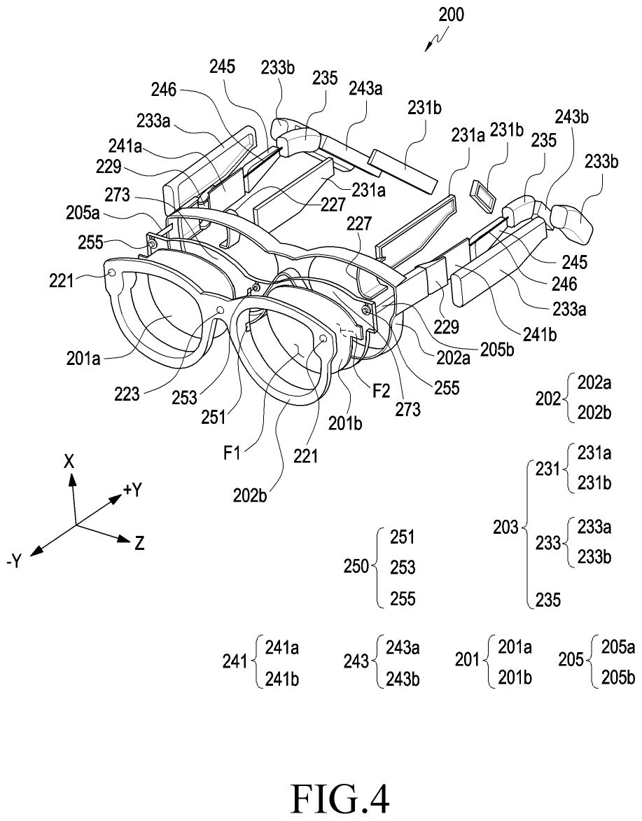

FIG. 4 is an exploded perspective view of a wearable electronic device 200 according to an embodiment of the disclosure.

The configurations of a display member 201, a lens frame 202, a wearable member 203, and a hinge structure 229 in FIG. 3 and/or FIG. 4 may be partially or entirely the same as the configurations of the display member 201, the lens frame 202, the wearable member 203, and the hinge structure 229 in FIG. 2.

Referring to FIGS. 3 and 4, a wearable electronic device 200 may include at least one display member 201, a lens frame 202, at least one wearable member 203, at least one hinge structure 229, at least one circuit board 241, at least one battery 243, at least one power transfer structure 246, at least one camera module 250, and/or at least one sensor module 280.

According to an embodiment, the wearable electronic device 200 may obtain and/or recognize a visual image about an object or an environment in a direction (e.g., the −Y-axis direction) in which a user looks or the wearable electronic device 200 is oriented by using the camera module 250 (e.g., the camera module 180 in FIG. 1), and may receive information on an object or an environment from an external electronic device (e.g., the electronic device 102 or 104 in FIG. 1 or the server 108 in FIG. 1) through a network (e.g., the first network 198 or the second network 199 in FIG. 1). In another embodiment, the wearable electronic device 200 may provide the received information on an object or an environment to a user in a sound or a visual form. The wearable electronic device 200 may provide the received information on an object or an environment to a user through the display member 201 in a visual form by using a display module (e.g., the display device 160 in FIG. 1). For example, the wearable electronic device 200 may be configured to implement information on an object or environment in a visual form and then to combine same with an actual image of a surrounding environment of a user, and thus the wearable electronic device 200 may implement an augmented reality.

According to an embodiment, one pair of display members 201 may be provided, and in a state where the wearable electronic device 200 is worn on the body of a user, the display members may be arranged to correspond to the left eye and the right eye of a user, respectively. For example, the display member 201 may include a first display member 201a and a second display member 201b disposed to be spaced apart from the first display member 201a. The first display member 201a may be disposed to correspond to the right eye of a user, and the second display member 201b may be disposed to correspond to the left eye of the user.

According to an embodiment, the display member 201 may include a first surface F1 oriented in a direction (e.g., the −Y-axis direction) in which external light is incident, and a second surface F2 oriented in a direction (e.g., the +Y-axis direction) opposite to the first surface F1. In a state where a user wears the wearable electronic device 200, at least a part of the light or the image incident through the first surface F1 may be incident into the left eye and/or the right eye of a user after passing through the second surface F2 of the display member 201, which is positioned to face the left eye and/or the right eye of the user.

According to an embodiment, the lens frame 202 may include at least two frames. For example, the lens frame 202 may include a first frame 202a and a second frame 202b. According to an embodiment, in case that a user wears the wearable electronic device 200, the first frame 202a may be a frame of a portion facing the face of a user, and the second frame 202b may be a part of the lens frame 202, which is spaced apart from the first frame 202a in the gaze direction (e.g., the −Y-axis direction) in which the user looks.

According to an embodiment, the wearable electronic device 200 may include at least one light output module 211 configured to provide an image and/or a picture to a user. For example, the light output module 211 may include a display panel (not shown) capable of outputting an image and a lens (not shown) configured to correspond to the eyes of a user and guide the picture to the display member 201. For example, a user may obtain an image output from the display panel of the light output module 211 through the lens of the light output module 211. According to various embodiments, the light output module 211 may include a device configured to display various information. For example, the light output module 211 may include at least one of a liquid crystal display (LCD) device, a digital mirror display (DMD) device, a liquid crystal on silicon (LCoS) device, an organic light emitting diode (OLED), or a micro light emitting diode (LED). According to an embodiment, in case that the light output module 211 and/or the display member 201 includes one of a liquid crystal display device, a digital mirror display device, or a liquid crystal on silicon device, the wearable electronic device 200 may include a light source for emitting light to a display area of the display member 201 and/or the light output module 211. According to another embodiment, in case that the light output module 211 and/or the display member 201 includes one of an organic light emitting diode or a micro-LED, the wearable electronic device 200 may provide a virtual image to a user without including a separate light source.

According to an embodiment, at least a part of the light output module 211 may be disposed in the housing 210. For example, the light output module 211 may be connected to the display member 201, and may be configured to provide an image to the user through the display member 201. For example, the image, which is output from the light output module 211, may be incident into the display member 201 through an input optical member (not shown) positioned at one end of the display member 201, and may be emitted toward the eyes of a user through an output optical member (not shown) and a waveguide (not shown) positioned in at least a part of the display member 201.

According to an embodiment, the wearable electronic device 200 may include the circuit board 241 (e.g., a printed circuit board (PCB), a printed board assembly (PBA), a flexible PCB (FPCB), or a rigid-flexible PCB (RFPCB)) for accommodating components for driving the wearable electronic device 200. For example, the circuit board 241 may include at least one integrated circuit chip, and at least one of a processor (not shown) (e.g., the processor 120 in FIG. 1), a memory (not shown) (e.g., the memory 130 in FIG. 1), a power management module (not shown) (e.g., the power management module 188 in FIG. 1), or a communication module (e.g., the communication module 190 in FIG. 1) may be provided on the integrated circuit chip. According to an embodiment, the circuit board 241 may be disposed in the wearable member 203 of the housing 210. For example, the circuit board 241 may include a first circuit board 241a disposed in the first wearable member 203a and a second circuit board 241b disposed in the second wearable member 203b. According to an embodiment, a communication module (e.g., the communication module 190 in FIG. 1) may be disposed on the first circuit board 241a positioned in the first wearable member 203a, and a processor (e.g., the processor 120 in FIG. 1) may be disposed on the second circuit board 241b positioned in the second wearable member 203b. According to an embodiment, the circuit board 241 may be electrically connected to the battery 243 (e.g., the battery 189 in FIG. 1) through the power transfer structure 246. According to an embodiment, the circuit board 241 may include an interposer substrate.

According to an embodiment, the battery 243 may be electrically connected to components (e.g., the light output module 211, the circuit board 241, the speaker module 245, the microphone module 247, and/or the camera module 250) of the wearable electronic device 200, and may supply power to the components of the wearable electronic device 200.

According to an embodiment, at least a part of the battery 243 may be disposed in the wearable member 203. According to an embodiment, the battery 243 may include a first battery 243a disposed in the first wearable member 203a and a second battery 243b disposed in the second wearable member 203b. According to an embodiment, the battery 243 may be disposed adjacent to each of the end 203c or 203d of the wearable member 203.

According to an embodiment, the speaker module 245 (e.g., the audio module 170 or the sound output device 155 in FIG. 1) may convert an electrical signal into a sound. At least a part of the speaker module 245 may be disposed in the wearable member 203 of the housing 210. According to an embodiment, the speaker module 245 may be positioned in the wearable member 203 to correspond to the ear of a user. According to an embodiment (e.g., FIG. 3), the speaker module 245 may be disposed next to the circuit board 241. For example, the speaker module 245 may be disposed between the circuit board 241 and the battery 243. According to another embodiment (not shown), the speaker module 245 may be disposed on the circuit board 241. For example, the speaker module 245 may be disposed between the circuit board 241 and an inner cover (e.g., the inner cover 231 in FIG. 4).

According to an embodiment, the wearable electronic device 200 may include the power transfer structure 246 configured to transfer power of the battery 243 to an electronic component (e.g., the light output module 211) of the wearable electronic device 200. For example, the power transfer structure 246 may be electrically connected to the battery 243 and/or the circuit board 241, and the circuit board 241 may be configured to deliver the power received through the power transfer structure 246 to the light output module 211. According to an embodiment, the power transfer structure 246 may be a configuration capable of delivering power. For example, the power transfer structure 246 may include a flexible printed circuit board or a wire. For example, the wire may include multiple cables (not shown). In various embodiments, the form of the power transfer structure 246 may be variously modified in consideration of the number and/or the kind of cables.

According to an embodiment, the microphone module 247 (e.g., the input device 150 and/or the audio module 170 in FIG. 1) may convert a sound into an electrical signal. According to an embodiment, the microphone module 247 may be disposed in the lens frame 202. For example, at least one microphone module 247 may be disposed at the lower end (e.g., in the direction toward the −X-axis) and/or the upper end (e.g., in the direction toward the +X-axis) of the wearable electronic device 200. According to an embodiment, the wearable electronic device 200 may more clearly recognize the voice of a user by using the voice information (e.g., sound) obtained from the at least one microphone module 247. For example, the wearable electronic device 200 may be configured to distinguish between voice information and an ambient noise, based on the obtained voice information and/or additional information (e.g., a low-frequency vibration of the skin and bone of a user). For example, the wearable electronic device 200 may be configured to clearly recognize the voice of a user, and may be configured to perform a function of reducing an ambient noise (e.g., a noise canceling).

According to an embodiment, the camera module 250 may photograph a still image and/or a moving image. The camera module 250 may include at least one of a lens, at least one image sensor, an image signal processor, or a flash. According to an embodiment, the camera module 250 may be disposed in the lens frame 202, and may be disposed around the display member 201.

According to an embodiment, the camera module 250 may include at least one first camera module 251. According to an embodiment, the first camera module 251 may photograph the eyes (e.g., pupil) or the gaze trajectory of a user. For example, the first camera module 251 may include a light-emitting part (e.g., an IR LED) (not shown) configured to emit light of an infrared band, and a camera structure (not shown) configured to photograph a reflection pattern of the light emitted to the eyes of a user by the light-emitting part. According to an embodiment, a processor (e.g., the processor 120 in FIG. 1) may adjust the position of a virtual image projected on the display member 201 so that the virtual image corresponds to the direction in which the pupils of a user gaze. According to an embodiment, the first camera module 251 may track the eyes or the gaze trajectory of a user by using multiple first camera modules 251 having an identical specification and performance.

According to an embodiment, the camera module 250 may include a second camera module 253. According to an embodiment, the second camera module 253 may photograph an external image. According to an embodiment, the second camera module 253 may photograph an external image through a second optical hole 223 formed through the second frame 202b. For example, the second camera module 253 may include a high-resolution color camera, and may be a high resolution (HR) or a photo video (PV) camera. According to an embodiment, the second camera module 253 may provide an auto focus (AF) function and an optical image stabilizer (OIS) function.

According to an embodiment (not shown), the wearable electronic device 200 may include a flash (not shown) positioned adjacent to the second camera module 253. For example, in case that an external image is obtained by the second camera module 253, the flash (not shown) may provide light for increasing the brightness (e.g., illuminance) around the wearable electronic device 200, and thus it may be possible to reduce the difficulty of image acquisition due to a dark environment, mixing of various light sources, and/or a light reflection.

According to an embodiment, the camera module 250 may include at least one third camera module 255. According to an embodiment, the third camera module 255 may photograph a motion of a user through a first optical hole 221 formed through the lens frame 202. For example, the third camera module 255 may photograph a gesture (e.g., a hand motion) of a user. The third camera module 255 and/or the first optical hole 221 may be arranged in each of opposite side ends of the lens frame 202 (e.g., the second frame 202b), for example, each of both ends of the lens frame 202 (e.g., the second frame 202b) in the Z-axis direction. According to an embodiment, the third camera module 255 may include a global shutter (GS) type camera. For example, the third camera module 255 may be a camera for supporting three degrees of freedom (3DoF) or 6DoF, and may provide 360-degree spatial (e.g., omnidirectional) recognition, position recognition, and/or movement recognition. According to an embodiment, the third camera module 255 may be a stereo camera, and may perform a simultaneous localization and mapping (SLAM) function and a user motion recognition function by using multiple global shutter type cameras having an identical specification and performance. According to an embodiment, the third camera module 255 may include an infrared (IR) camera (e.g., a time of flight (TOF) camera or a structured light camera). For example, the IR camera may operate as at least a part of a sensor module (e.g., the sensor module 176 in FIG. 1) for detecting a distance to a subject.

According to an embodiment, at least one of the first camera module 251 or the third camera module 255 may be replaced with a sensor module (e.g., the sensor module 176 in FIG. 1). For example, the sensor module may include at least one of a vertical cavity surface emitting laser (VCSEL), an infrared sensor, and/or a photodiode. For example, the photodiode may include a positive intrinsic negative (PIN) photodiode or an avalanche photodiode (APD). The photodiode may be referred to as a photo detector or photo sensor.

According to an embodiment, at least one of the first camera module 251, the second camera module 253, or the third camera module 255 may include multiple camera modules (not shown). For example, the second camera module 253 may include multiple lenses (e.g., a wide-angle and a telephoto lens) and image sensors and may be disposed on one surface (e.g., the surface oriented in the −Y-axis direction) of the wearable electronic device 200. For example, the wearable electronic device 200 may include multiple camera modules having different attributes (e.g., angle of view) or functions, and based on a selection of a user and/or trajectory information, may be configured to control so as to change the angle of view the camera module. For example, at least one of the multiple camera modules may be a wide-angle camera, and at least another one thereof may be a telephoto camera.

According to an embodiment, a processor (e.g., the processor 120 in FIG. 1) may determine a movement of the wearable electronic device 200 and/or a motion of a user, by using information on the wearable electronic device 200, which is obtained using at least one of a gesture sensor, a gyro sensor, or an acceleration sensor of a sensor module (e.g., the sensor module 176 in FIG. 1), and a motion (e.g., the access of the body of a user to the wearable electronic device 200) of a user obtained using the third camera module 255. According to an embodiment, the wearable electronic device 200 may include a magnetism (terrestrial magnetism) sensor capable of measuring the bearing by using a magnetic field and a magnetic field line, and/or a Hall effect IC capable of obtaining the motion information (e.g., a movement direction or a moving distance) by using a magnetic field strength, in addition to the described sensor. Here, the Hall effect IC may also be referred to as a Hall sensor. For example, a processor may determine a movement of the wearable electronic device 200 and/or a motion of a user, based on information obtained from the magnetism (terrestrial magnetism) sensor and/or the Hall effect IC.

According to an embodiment (not shown), the wearable electronic device 200 may perform an input function (e.g., a touch function and/or a pressure sensing function) capable of interacting with a user. For example, an element (e.g., a touch sensor and/or a pressure sensor), which is configured to perform a touch function and/or a pressure detection function, may be disposed in at least a part of the wearable member 203. The wearable electronic device 200 may be configured to control a virtual image output through the display member 201, based on the information obtained through the element. For example, a sensor related to a touch function and/or a pressure detection function may be formed in various types such as a resistive type, a capacitive type, an electro-magnetic (EM) type, or an optical type. According to an embodiment, the element, which is configured to perform a touch function and/or a pressure detection function, may be partially or entirely the same as the configuration of the input device 150 in FIG. 1.

According to an embodiment, the wearable electronic device 200 may include a reinforcement member 260 which is disposed in the inner space of the lens frame 202 and formed to have a rigidity higher than the rigidity of the lens frame 202.

According to an embodiment, the wearable electronic device 200 may include a lens structure 273. The lens structure 273 may refract at least a portion of light. For example, the lens structure 273 may be a prescription lens having a designated refractive index. According to an embodiment, at least a part of the lens structure 273 may be disposed at the rear side (e.g., in the +Y-axis direction) of the display member 201. For example, the lens structure 273 may be positioned between the display member 201 and the eyes of a user.

According to an embodiment, the housing 210 may include a hinge cover 227 capable of covering one portion of the hinge structure 229. Another one portion of the hinge structure 229 may be accommodated or covered between an inner cover 231 and an outer cover 233 to be described later.

According to an embodiment, the wearable member 203 may include the inner cover 231 and the outer cover 233. For example, the inner cover 231 may be a cover which faces the body of a user or is configured to be in directly contact with the body of the user, and may be made of a material having low thermal conductivity, for example, a synthetic resin. According to an embodiment, the inner cover 231 may include an inner surface (e.g., the inner surface 231c in FIG. 2) facing the body of a user. For example, the outer cover 233 may include a material (e.g., a metal) capable of transferring heat at least partially, and may be coupled to face the inner cover 231. According to an embodiment, the outer cover 233 may include an outer surface (e.g., the outer surface 231d in FIG. 2) opposite to the inner surface 231c. In an embodiment, at least one of the circuit board 241 or the speaker module 245 may be accommodated in a space separated from the battery 243 in the wearable member 203. In the illustrated embodiment, the inner cover 231 may include a first cover 231a for accommodating the circuit board 241 and/or the speaker module 245, and a second cover 231b accommodating the battery 243, and the outer cover 233 may include a third cover 233a coupled to face the first cover 231a and a fourth cover 233b coupled to face the second cover 231b. For example, the first cover 231a and the third cover 233a (hereinafter, a “first cover portion 231a and 233b”) may be coupled to each other so as to accommodate the circuit board 241 and/or the speaker module 245, and the second cover 231b and the fourth cover 233b (hereinafter, a “second cover portion 231b and 233b”) may be coupled to each other so as to accommodate the battery 243.

According to an embodiment, the first cover portion 231a and 233a may be rotatably coupled to the lens frame 202 through the hinge structure 229, and the second cover portion 231b and 233b may be connected or mounted to the end of the first cover portion 231a and 233a through a connection structure 235. According to an embodiment, a portion of the connection structure 235, which is in contact with the body of a user, may be made of a material having low thermal conductivity, for example, an elastic body material such as silicone, polyurethane, or rubber, and a portion not contact with the body of the user may be made of a material (e.g., a metal material) having high thermal conductivity. For example, in case heat is generated from the circuit board 241 or the battery 243, the connection structure 235 may block heat transfer to the portion in contact with the body of a user, and thus may disperse or dissipate heat through the portion not in contact with the body of the user. According to an embodiment, the portion of the connection structure 235, which is implemented to come into contact with the body of a user, may be interpreted as a part of the inner cover 231, and the portion of the connection structure 235, which does not come into contact with the body of the user, may be interpreted as a part of the outer cover 233. According to an embodiment (not shown), the first cover 231a and the second cover 231b may be integrally formed without the connection structure 235, and the third cover 233a and the fourth cover 233b may be integrally formed without the connection structure 235. According to an embodiment, the wearable electronic device may further include other elements (e.g., the antenna module 197 in FIG. 1) in addition to the illustrated elements, and may receive, by using a communication module (e.g., the communication module 190 in FIG. 1), information on an object or an environment provided from an external electronic device (e.g., the electronic device 102 or 104 in FIG. 1 or the server 108 in FIG. 1) through a network (e.g., the first network 198 or the second network 199 in FIG. 1).

According to an embodiment, the lens frame 202 may include a connection portion 274 between the first display member 201a and the second display member 201b. For example, the connection portion 274 may be interpreted as a portion corresponding to the nose pad of eyeglasses.

According to an embodiment, the wearable electronic device 200 may include a connection member 205. According to an embodiment, the circuit board 241 may be connected to the connection member 205, and may deliver an electrical signal to components (e.g., the light output module 211 and/or the camera module 250) of the wearable electronic device 200 through the connection member 205. For example, a control signal delivered from a processor (e.g., the processor 120 in FIG. 1) positioned on the circuit board 241 may be delivered to electronic components by using at least a part of the connection member 205. For example, at least a part of the connection member 205 may include a wire (not shown) electrically connected to components of the wearable electronic device 200.

According to an embodiment, the connection member 205 may include a first connection member 205a of which at least a part is disposed in the first wearable member 203a, and a second connection member 205b of which at least a part is disposed in the second wearable member 203b. According to an embodiment, at least a part of the first connection member 205a and/or the second connection member 205b may face the hinge structure 229. For example, the first connection member 205a may extend to the inside of the lens frame 202 while crossing the hinge structure 229 from the first circuit board 241a. The second connection member 205b may extend to the inside of the lens frame 202 while crossing the hinge structure 229 from the second circuit board 241b. For example, a part of the first connection member 205a and a part of the second connection member 205b may be arranged in the wearable member 203, and another part of each thereof may be arranged in the lens frame 202.

According to an embodiment, each of the first connection member 205a and the second connection member 205b may include a structure which can be folded or unfolded based on the rotation of the hinge structure 229. For example, the first connection member 205a and/or the second connection member 205b may include a flexible printed circuit board (FPCB). According to an embodiment, the first connection member 205a may be electrically and/or mechanically connected to the first circuit board 241a. According to an embodiment, the second connection member 205b may be electrically and/or mechanically connected to the second circuit board 241b. According to an embodiment, the first connection member 205a and/or the second connection member 205b may include a structure (e.g., a wire and/or a cable) for transmitting a signal.

According to an embodiment, the sensor module 280 (e.g., the sensor module 176 in FIG. 1) may detect light having passed through the display member 201. According to an embodiment, the sensor module 280 may include a first sensor module 281 capable of detecting light having passed through the first display member 201a, and a second sensor module 282 capable of detecting light having passed through the second display member 201b. For example, the first sensor module 281 may detect light from the rear side (e.g., in the +Y-axis direction) of the first display member 201a, and the second sensor module 282 may detect light from the rear side of the second display member 201b. According to an embodiment, the sensor module 280 may include a third sensor module 283 capable of detecting light from the front side (e.g., in the −Y-axis direction) of the display member 201. For example, the third sensor module 283 may detect light from the front side (e.g., in the −Y-axis direction) of the display member 201. According to an embodiment, the sensor module 280 may be an illuminance sensor. According to an embodiment, the third sensor module 283 may have a configuration partially or entirely the same as the configuration of the second camera module 253.

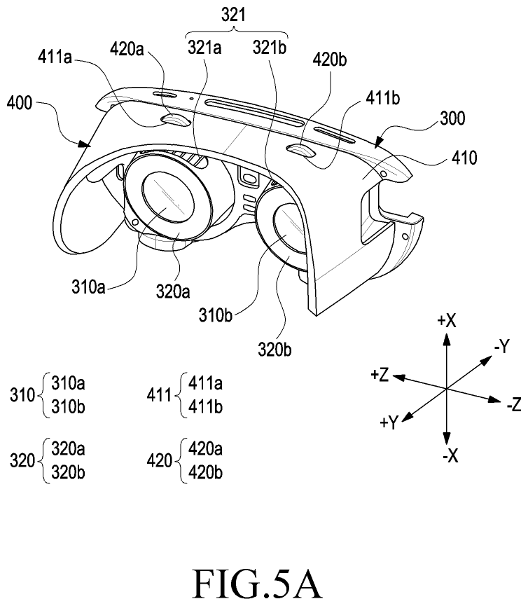

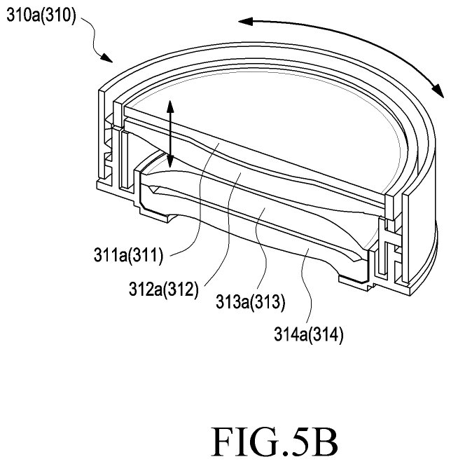

FIG. 5A is a view showing a face cover 400 coupled to a head-mounted display apparatus 300 according to an embodiment of the disclosure.

FIG. 5B is a view showing a cross section of a pair of lenses 310 of a head-mounted display apparatus according to an embodiment of the disclosure.

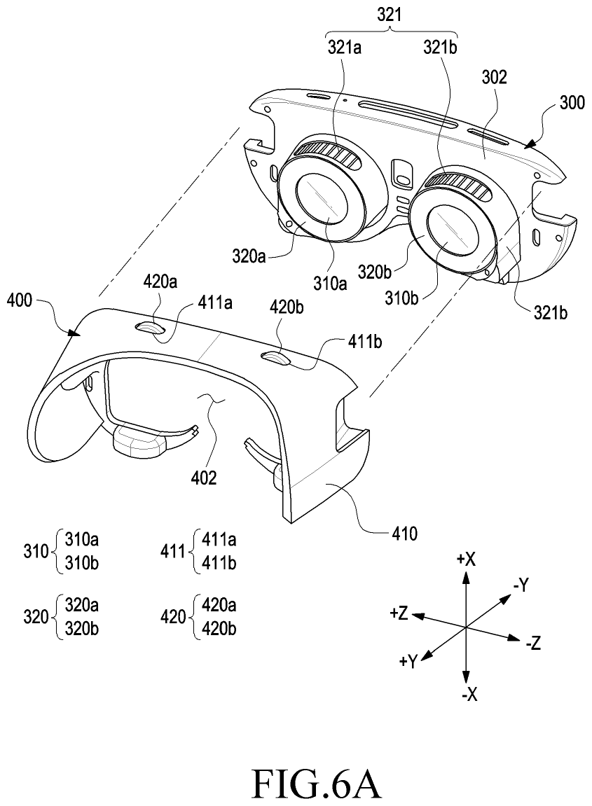

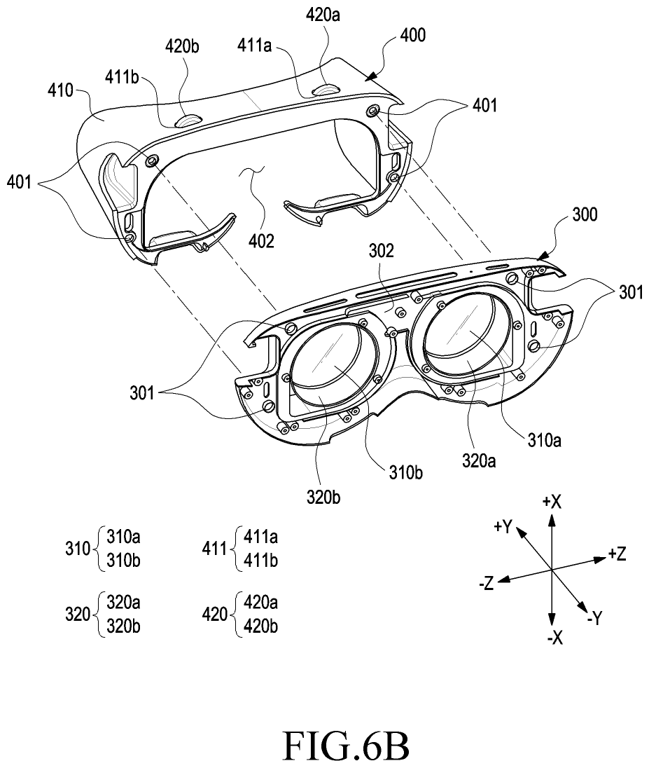

FIGS. 6A and 6B are views showing a head-mounted display apparatus 300 and a face cover 400 according to various embodiments of the disclosure.

Referring to FIGS. 5A, 5B, 6A, and 6B, a head-mounted display apparatus 300 may include a pair of lenses 310 and a pair of lens barrels 320. A face cover 400 may be detachably coupled to the head-mounted display apparatus 300. The configuration of the head-mounted display apparatus 300 in FIGS. 5A, 5B, 6A, and 6B may be partially or entirely the same as the configuration of the wearable electronic device 200 in FIGS. 2 to 4. The structure in FIGS. 5A, 5B, 6A, and 6B may be selectively combined with the structure in FIGS. 2 to 4.

According to an embodiment, the head-mounted display (HMD) apparatus 300 may be mounted on a portion of a human body, for example, the head, and may function to display an image. For example, the head-mounted display apparatus 300 may be formed in a goggle shape or an eyeglass shape. The head-mounted display apparatus 300 may have a display which is positioned at a position facing the eyes of a user and outputs an image.

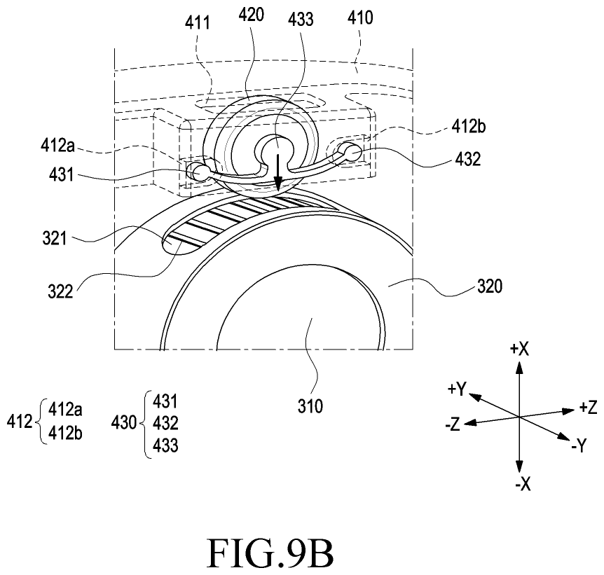

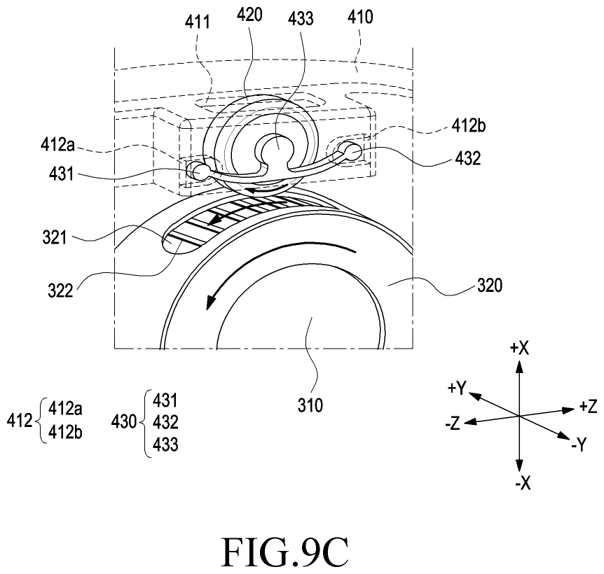

According to an embodiment, the head-mounted display apparatus 300 may include a body part 302, a pair of lenses 310 positioned between a user and the display to be able to correct the eyesight of the user, and a pair of lens barrels 320 coupled to the body part 302, surrounding the pair of lenses 310, and configured to adjust positions of the lenses. The pair of lenses 310 may have an adjustable focus so that a screen output on the display can be seen by the eyes of a user. For example, each of the pair of lenses 310 may include at least one of a Fresnel lens, a Pancake lens, or a multi-channel lens. The pair of lenses 310 may include a first lens 310a corresponding to the left eye of a user and a second lens 310b corresponding to the right eye the user. The pair of lens barrels 320 may include a first lens barrel 320a configured to surround the first lens 310a, and a second lens barrel 320b configured to surround the second lens 310b. According to an embodiment, the pair of lens barrels 320 may include a pair of wheels 321 for adjusting the diopter of the lenses. The pair of wheels 321 may be formed so that at least a portion of each thereof is exposed through an opening formed through each of the first lens barrel 320a and/or the second lens barrel 320b. The pair of wheels 321 may include a first wheel 321a positioned on the first lens barrel 320a, and a second wheel 321b positioned on the second lens barrel 320b. In case that each of the pair of wheels 321 comes into contact with the lens adjustment member 420, each of the pair of wheels may rotate in response to the rotation of the lens adjustment member 420. Each of the pair of wheels 321 may include multiple grooves (e.g., 322 in FIG. 9A) or protrusions (not shown) which increase a friction force and thus enable the rotational force with the lens adjustment member 420 to be easily transmitted thereto. The multiple grooves (e.g., 322 in FIG. 9A) may be recessed in the-X-axis direction in the form of a straight line corresponding to the Y-axis and be arranged to be spaced a predetermined interval apart from each other. In case that the pair of wheels 321 rotate in the clockwise direction or the counterclockwise direction, the pair of lens barrels 320 may rotate the clockwise direction or the counterclockwise direction to correspond to the movement direction of the pair of wheels 321, and at the same time, the positions of the pair of lens barrels 320 and the pair of lenses 310 may be adjusted in the front or the rear direction (e.g., the −Y-axis direction or the +Y-axis direction in FIG. 6A) thereof so that the diopter of the lenses can be adjusted. For example, the first wheel 321a may adjust a position of the first lens 310a, and the second wheel 321b may adjust a position of the second lens 310b. According to an embodiment, the first wheel 321a and the second wheel 321b may move integrally with each other. According to an embodiment, the first wheel 321a and the second wheel 321b may move separately.

According to an embodiment, each of the pair of lenses 310 may include multiple lenses. Each of the pair of lenses 310 may include multiple lenses arranged in the Y-axis direction to overlap each other. Each of the pair of lenses 310 may include multiple front lenses 311 and 312, and multiple rear lenses 313 and 314 arranged at the rear side of the multiple front lenses 311 and 312. The multiple front lenses 311 and 312 may include a first front lens 311 and a second front lens 312 arranged to overlap each other. The multiple rear lenses 313 and 314 may include a first rear lens 313 and a second rear lens 314 arranged to overlap each other. For example, the first lens 310a may include a (1-1)th front lens 311a, a (1-2)th front lens 312a, a (1-1)th rear lens 313a, and a (1-2)th rear lens 314a. For example, the second lens 310b may include a (2-1)th front lens 311b, a (2-2)th front lens 312b, a (2-1)th rear lens 313b, and a (2-2)th rear lens 314b.

According to an embodiment, the pair of lenses 310 may be configured to correct eyesight and have an adjustable diopter by adjusting the distance between one or more lenses among multiple lenses through the rotation of the lens adjustment member 420. For example, the positions of the multiple front lenses 311 and 312 of the pair of lenses 310 may be adjusted in the front or the rear direction (e.g., the −Y-axis direction or the +Y-axis direction in FIG. 6A) in response to the rotation of the lens adjustment member 420. According to an embodiment, in case that the lens adjustment member 420 rotates in the clockwise direction or the counterclockwise direction, the pair of wheels 321 may rotate in the clockwise direction or the counterclockwise direction in response thereto so that the pair of lens barrels 320 rotate in the clockwise direction or the counterclockwise direction to correspond to the movement direction of the pair of wheels 321, and at the same time, the positions of the pair of lens barrels 320 and the multiple front lenses 311 and 312 of the pair of lenses 310 may be adjusted in the front or the rear direction (e.g., the −Y-axis direction or the +Y-axis direction in FIG. 6A) thereof so that the diopter of the lenses can be adjusted.

According to an embodiment, the face cover 400 may be a member (an accessory) which surrounds the space between the face of a user and the head-mounted display apparatus 300 in order to maximize feeling of immersion of the user. A portion of the face cover 400 may be formed to be coupled to the head-mounted display apparatus 300, and another portion thereof may be formed to correspond to the face of a person.

Referring to FIG. 6B, the face cover 400 may be detachably coupled to the head-mounted display apparatus 300. According to an embodiment, multiple first magnets 301 may be arranged on the head-mounted display apparatus 300. For example, the multiple first magnets 301 may be arranged on a surface of the head-mounted display apparatus 300, which faces the face cover 400. According to an embodiment, multiple second magnets 401 corresponding to the multiple first magnets 301 may be arranged on the face cover 400. For example, the multiple second magnets 401 may be arranged on a surface of the face cover 400, which faces the head-mounted display apparatus 300. For example, in case that the multiple first magnets 301 are an N-pole, the multiple second magnets 401 may be an S-pole. For example, in case that the multiple first magnets 301 are an S-pole, the multiple second magnets 401 may be an N-pole. For example, the multiple first magnets 301 and the multiple second magnets 401 may be four or more. The face cover 400 may be coupled to the head-mounted display apparatus 300 by the magnetic force of the multiple first magnets 301 and the multiple second magnets 401 and be separated from each other. According to an embodiment, the multiple first magnets 301 may be arranged on the head-mounted display apparatus 300, and the face cover 400 may include metal. For example, the multiple first magnets 301 may be arranged on a surface of the head-mounted display apparatus 300, which faces the face cover 400, and at least a part of a surface, which faces the head-mounted display apparatus 300, of the face cover 400 may include a metal member (not shown). The multiple first magnets 301 of the head-mounted display apparatus 300 and the metal member (not shown) of the face cover 400 may be coupled by the magnetic force thereof, and be separated from each other. According to an embodiment, the multiple second magnets 401 may be arranged on the face cover 400, and the head-mounted display apparatus 300 may include metal. For example, the multiple second magnets 401 may be arranged on a surface of the face cover 400, which faces the head-mounted display apparatus 300, and at least a part of a surface, which faces the face cover 400, of the head-mounted display apparatus 300 may include a metal member (not shown). The multiple second magnets 401 of the face cover 400 and the metal member (not shown) of the head-mounted display apparatus 300 may be coupled by the magnetic force thereof, and be separated from each other. However, the method, in which the face cover 400 and the head-mounted display apparatus 300 are coupled to each other, is not limited to the embodiment, and may be variously designed and thus changed.

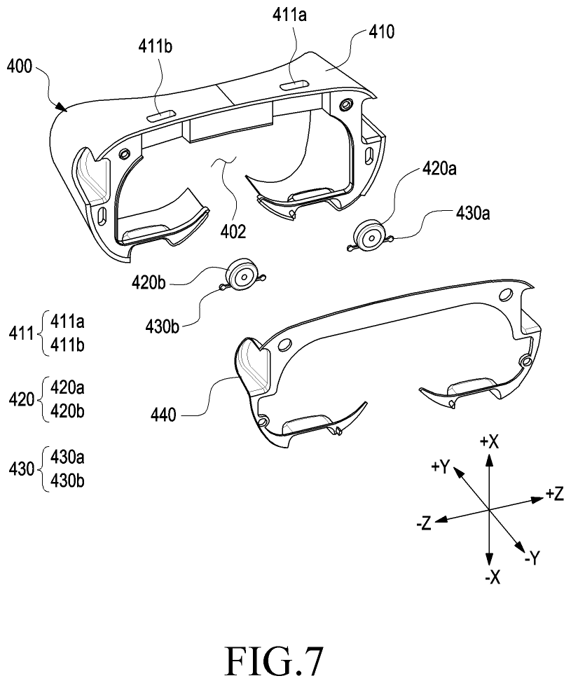

FIG. 7 is an exploded perspective view showing a face cover 400 according to an embodiment of the disclosure.

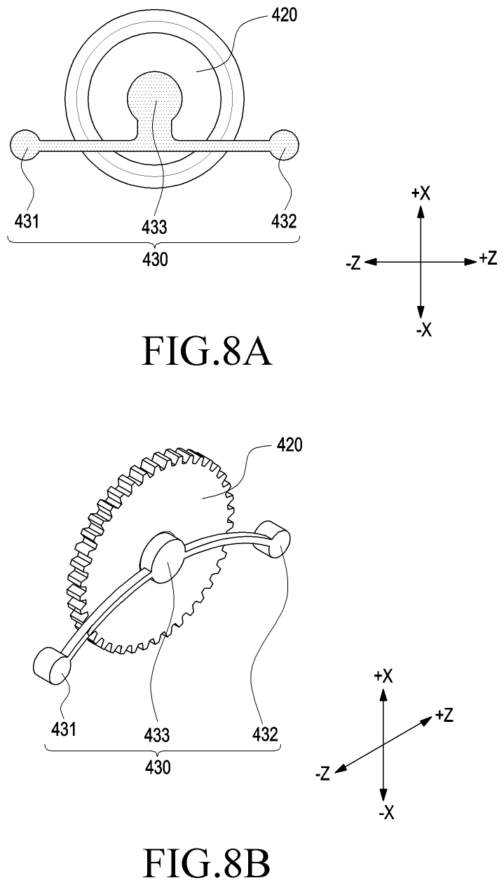

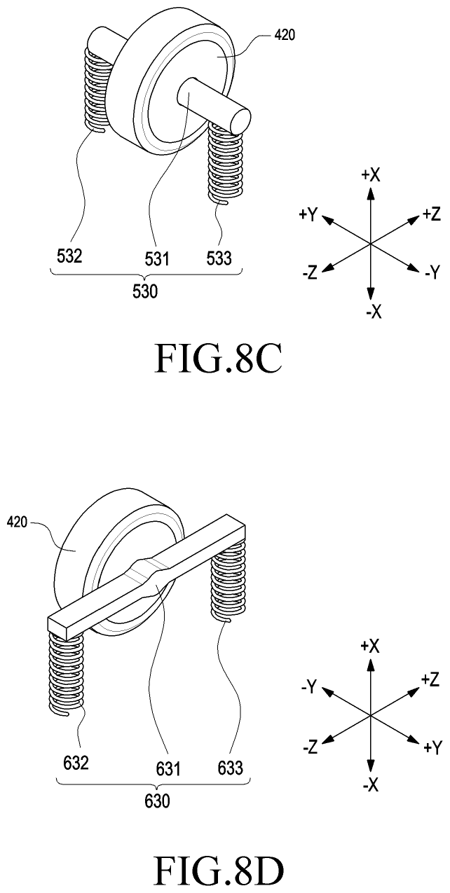

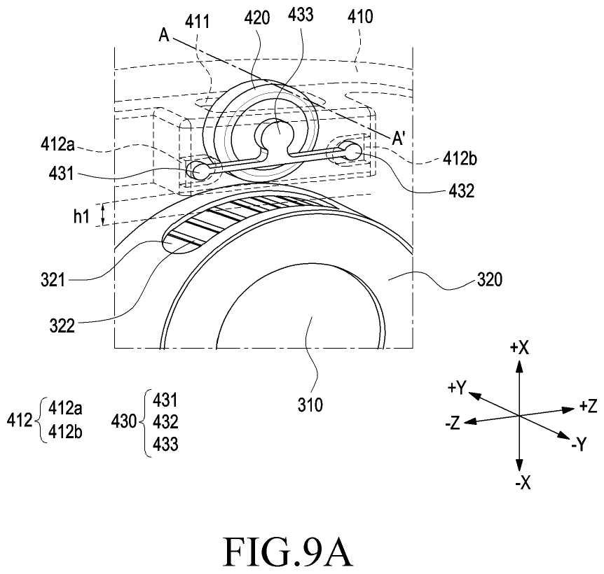

FIGS. 8A, 8B, 8C, and 8D are views showing a lens adjustment member 420 and an elastic member 430 according to various embodiments of the disclosure.

Referring to FIGS. 7, 8A, 8B, 8C, and 8D, the face cover 400 may include a housing 410, a lens adjustment member 420, an elastic member 430, and a rear plate 440. The configuration of the face cover 400 in FIGS. 7, 8A, 8B, 8C, and 8D may be partially or entirely the same as the configuration of the face cover 400 in FIGS. 5A, 5B, 6A, and 6B. The structure in FIGS. 7, 8A, 8B, 8C, 8D may be selectively combined with the structure in FIGS. 5A, 5B, 6A, and 6B.

According to an embodiment, the housing 410 may be positioned in the front direction (e.g., the −Y-axis direction in FIG. 7) of the eyes of a user. The front surface of the housing 410 may be formed to have a flat surface or a curved surface, but the rear surface (e.g., the surface in the +Y-axis direction in FIG. 7) of the housing 410 may include a curved surface which is curved to correspond to the shape of the face of a user. The housing 410 may have a shape similar to goggles. The housing 410 may include an accommodation portion 402 which is open in the front direction (e.g., the −Y-axis direction in FIG. 7) or the rear direction (e.g., the +Y-axis direction in FIG. 7) thereof. The accommodation portion 402 may be a portion formed in the housing, and may be defined or interpreted as an element of the housing. The accommodation portion 402 may be a structure capable of accommodating at least a part of the head-mounted display apparatus 300. For example, at least a part of the head-mounted display apparatus 300 may be inserted in the accommodation portion 402. According to an embodiment, the housing 410 may be configured to be coupled to a head fixation member (not shown) such as an eyeglass temple for fixing eyeglasses to the face of a user. According to an embodiment, the housing 410 may be formed by injection of synthetic resin or be formed of metal, for example, at least one metal of stainless steel (STS), aluminum (Al), titanium (Ti), and the like.

According to an embodiment, at least one opening 411 may be formed in one area of the housing 410. According to an embodiment, the opening 411 may be formed at a position corresponding to the lenses 310 of the head-mounted display apparatus 300 in case that the face cover 400 is coupled to the head-mounted display apparatus 300. For example, the at least one opening 411 may include a first opening 411a corresponding to the first lens 310a of the head-mounted display apparatus 300, and a second opening 411b corresponding to the second lens 310b of the head-mounted display apparatus 300. For example, the opening 411 may be formed in the surface in the upper direction (e.g., the +X-axis direction in FIG. 7) of the housing 410. However, the position, at which the opening 411 is formed, is not limited to the embodiment, and may be variously designed and thus changed.

According to an embodiment, at least one lens adjustment member 420 may have at least a portion extending through the opening 411 and at least a portion disposed to be exposed to the outside. According to an embodiment, the at least one lens adjustment member 420 may be a circular shape. According to an embodiment, the at least one lens adjustment member 420 may have a diameter shorter than the width of the opening 411, and thus the lens adjustment member 420 may be inserted and/or fixed into the opening 411. For example, the at least one lens adjustment member 420 may include a first lens adjustment member 420a extending through the first opening 411a, and a second lens adjustment member 420b extending through the second opening 411b. According to an embodiment, the at least one lens adjustment member 420 may be rotated in a first rotation direction or a second rotation direction (a clockwise direction or a counterclockwise direction) opposite to the first rotation direction by a user. For example, the at least one lens adjustment member 420 may be a rotating circular member such as a wheel illustrated in FIG. 8A or a gear illustrated in FIG. 8B. According to an embodiment, the at least one lens adjustment member 420 may be coupled to face each of the pair of lens barrels 320 of the head-mounted display apparatus 300. According to an embodiment, in case that the least one lens adjustment member 420 comes into contact with each of the pair of wheels 321 formed on the pair of lens barrels 320, the pair of lens barrels 320 may rotate in response to the rotation of the pair of wheels 321.

According to an embodiment, at least one elastic member 430 may have a portion coupled to the lens adjustment member 420, and another portion coupled to the housing 410 or the opening 411. For example, the at least one elastic member 430 may include a first elastic member 430a coupled to the first lens adjustment member 420a, and a second elastic member 430b coupled to the second lens adjustment member 420b. According to an embodiment, the at least one elastic member 430 may have opposite ends fixed to the housing 410 and a central portion coupled to the lens adjustment member 420. According to an embodiment, the elastic member 430 may include a first portion 431 fixed to a portion of the housing 410, which surrounds the opening 411, a second portion 432 fixed to another portion of the housing 410, which surrounds the opening 411, and a third portion 433 between the first portion 431 and the second portion 432, which is coupled to a central shaft of the lens adjustment member 420. The elastic member 430 may provide an elastic force which allows the lens adjustment member 420 to move in a second direction (e.g., the upper direction or the +X-axis direction in FIG. 7) or in a first direction (e.g., the lower direction or the −X-axis direction in FIG. 7) opposite to the second direction. For example, the elastic member 430 may be a plate spring. For example, referring to FIG. 8A, the elastic member 430 may include a straight portion and be formed so that the first portion 431, the second portion 432, and/or the third portion 433 protrude. For example, referring to FIG. 8B, the elastic member 430 may include a curved portion and be formed so that the first portion 431, the second portion 432, and/or the third portion 433 protrude. Protruding portions, such as the first portion 431, the second portion 432, and/or the third portion 433, may be formed to provide a large contact area in order to improve a fixation force. For example, the protruding portions such as the first portion 431, the second portion 432, and/or the third portion 433 may be formed to have a circular shape. However, the shape and the structure of the elastic member 430 are not limited to the embodiment, and may be variously designed and thus changed. According to an embodiment, referring to FIG. 8C, the elastic member 530 may include a bar 531 connected to the central shaft of the lens adjustment member 420, a first spring 532 coupled to one end of the bar 531, and a second spring 533 coupled to the other end of the bar 531. For example, the bar 531 may be disposed in the form of extending through the central axis of the lens adjustment member 420 and may correspond to the Y-axis in FIG. 8C. The first spring 532 coupled to one end of the bar 531 and the second spring 533 coupled to the other end thereof may be arranged in the front direction (e.g., the −Y-axis direction in FIG. 8C) and the rear direction (e.g., the +Y-axis direction in FIG. 8C) of the lens adjustment member 420, respectively. According to an embodiment, the first spring 532 and/or the second spring 533 may be vertically coupled to the ends of the bar 531 (e.g., may be disposed to correspond to the X-axis in FIG. 8C). For example, each of the first spring 532 and/or the second spring 533 may have one end coupled to the bar 531 and the other end coupled and/or fixed to a portion of the housing 410, which surrounds the opening 411. The elastic member 530 may provide an elastic force which allows the lens adjustment member 420 to move in the second direction (e.g., the upper direction or the +X-axis direction) or in the first direction (e.g., the lower direction or the −X-axis direction) opposite to the second direction. According to an embodiment, the elastic member 530 may move in response to a movement in the upper direction (e.g., the +X-axis direction) or the lower direction (e.g., the −X-axis direction) of the lens adjustment member 420. For example, in case that the lens adjustment member 420 is pressed in the first direction (e.g., the lower direction or the −X-axis direction) by a user, the bar 531 coupled to lens adjustment member 420 may also be moved in the first direction (e.g., the lower direction or the −X-axis direction), and thus the first spring 532 and/or the second spring 533 connected to the bar 531 may be compressed. For example, in case that a force is not applied to the lens adjustment member 420 by a user, the first spring 532 and/or the second spring 533, which has been compressed, may return to the original state thereof by the elastic force, and thus the lens adjustment member 420 and the bar 531 coupled thereto may also move in the second direction (e.g., the upper direction or the +X-axis direction). For example, the first spring 532 and the second spring 533 may be coil springs.

Referring to FIG. 8D, the elastic member 630 may include a bar 631 connected to the central shaft of the lens adjustment member 420, a first spring 632 coupled to one end of the bar 631, and a second spring 633 coupled to the other end of the bar 631. For example, referring to FIG. 8D, the central portion of the bar 631 may be coupled to the central shaft of the lens adjustment member 420 and thus be disposed to correspond to the Z-axis in FIG. 8D. The first spring 632 coupled to one end of the bar 631 and the second spring 633 coupled to the other end thereof may be arranged in the left direction (e.g., the −Z-axis direction in FIG. 8D) and the right direction (e.g., the +Z-axis direction in FIG. 8D) of the lens adjustment member 420, respectively. According to an embodiment, the first spring 632 and/or the second spring 633 may be vertically coupled to the ends of the bar 631 (e.g., may be disposed to correspond to the X-axis in FIG. 8C). For example, each of the first spring 632 and/or the second spring 633 may have one end coupled to the bar 631 and the other end coupled and/or fixed to a portion of the housing 410, which surrounds the opening 411. The elastic member 630 may provide an elastic force which allows the lens adjustment member 420 to move in the second direction (e.g., the upper direction or the +X-axis direction) or in the first direction (e.g., the lower direction or the −X-axis direction) opposite to the second direction. According to an embodiment, the elastic member 630 may move in response to a movement in the upper direction (e.g., the +X-axis direction) or the lower direction (e.g., the −X-axis direction) of the lens adjustment member 420. For example, in case that the lens adjustment member 420 is pressed in the first direction (e.g., the lower direction or the −X-axis direction) by a user, the bar 631 coupled to lens adjustment member 420 may also be moved in the first direction (e.g., the lower direction or the −X-axis direction), and thus the first spring 632 and/or the second spring 633 connected to the bar 631 may be compressed. For example, in case that an external force (e.g., a force applied by the finger of a user) applied to the lens adjustment member 420 by a user is removed, the first spring 632 and/or the second spring 633, which has been compressed, may return to the original state thereof by the elastic force, and thus the lens adjustment member 420 and the bar 631 coupled thereto may also move in the second direction (e.g., the upper direction or the +X-axis direction). For example, the first spring 632 and the second spring 633 may be coil springs.

FIGS. 9A, 9B, and 9C are views showing a process in which the diopter of lenses is adjusted according to various embodiments of the disclosure.

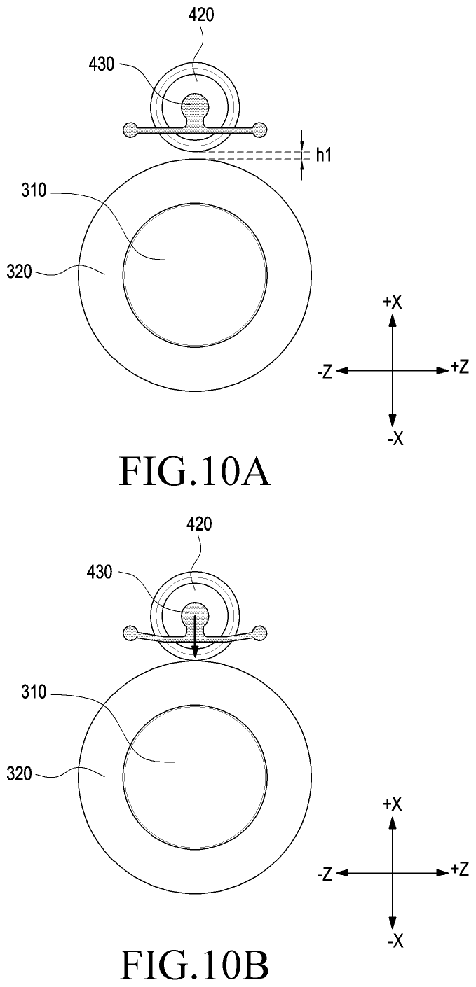

FIGS. 10A and 10B are views showing changes in the positions of a lens adjustment member 420 and an elastic member 430 according to various embodiments of the disclosure.

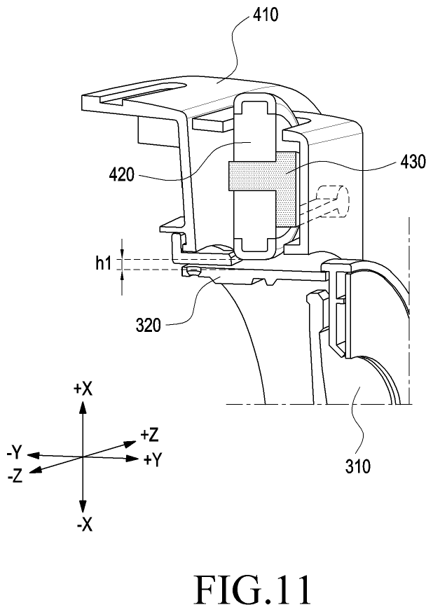

FIG. 11 is a cross-sectional view showing a combined state of a head-mounted display apparatus 300 and a face cover 400, taken along line A-A′ in FIG. 9A according to an embodiment of the disclosure.

Referring to FIGS. 9A, 9B, 9C, 10A, 10B, and 11, a head-mounted display apparatus 300 may include a pair of lenses 310 and a pair of lens barrels 320, and a face cover 400 may include a housing 410, at least one lens adjustment member 420, at least one elastic member 430, and a rear plate (e.g., the rear plate 440 in FIG. 7). The configuration of the head-mounted display apparatus 300 and the face cover 400 in FIGS. 9A, 9B, 9C, 10A, 10B, and 11 may be partially or entirely the same as the head-mounted display apparatus 300 and the face cover 400 in FIGS. 7, 8A, 8B, 8C, and 8D. The structure in FIGS. 9A, 9B, 9C, 10A, 10B, and FIG. 11 may be selectively combined with the structure in FIGS. 7, 8A, 8B, 8C, and 8D.

According to an embodiment, the lens adjustment member 420 and the elastic member 430 coupled to the lens adjustment member 420 may be arranged through an opening 411. According to an embodiment, the lens adjustment member 420 disposed in the housing 410 may have at least a part exposed to the outside through the opening 411. According to an embodiment, the elastic member 430 coupled to the lens adjustment member 420 may be coupled and/or fixed to a recess portion 412 of the housing 410. The elastic member 430 may have a first portion 431 disposed in a first recess portion 412a, and a second portion 432 disposed in a second recess portion 412b. According to an embodiment, the recess portion 412 may be a portion of a region, which surrounds the opening 411, of the housing, and the portion may be recessed from the opening 411 to the inner portion of the housing. For example, the first recess portion 412a may be a portion formed by recessing a part of the housing 410 in the left direction (e.g., the −Z-axis direction in FIG. 9A) from a left portion (e.g., a surface in the −Z-axis direction in FIG. 9A) of the opening 411. For example, the second recess portion 412b may be a portion formed by recessing a part of the housing 410 in the right direction (e.g., the +Z-axis direction in FIG. 9A) from a right portion (e.g., a surface in the +Z-axis direction in FIG. 9A) of the opening 411. According to an embodiment, the lens adjustment member 420 and the elastic member 430 coupled to the lens adjustment member 420 may be arranged to correspond to each of the pair of lenses 310 and each of the pair of lens barrels 320 surrounding the pair of lenses. For example, the lens adjustment member 420 and the elastic member 430 coupled to the lens adjustment member 420 may be arranged to be spaced in the upper direction (e.g., the +X-axis direction in FIG. 9A) from each of the pair of lenses 310 and each of the pair of lens barrels 320 surrounding the pair of lenses. For example, the lens adjustment member 420 and each of the pair of lens barrels 320 may be arranged to be spaced apart by a first distance (e.g., h1 in FIG. 9A).

According to an embodiment, a user may press the lens adjustment member 420, of which a part is disposed to protrude in the upper direction (e.g., the +X-axis direction in FIG. 9A) of the opening 411, in the first direction (e.g., the lower direction or the −X-axis direction in FIG. 9B). In case that the user presses the lens adjustment member 420 in the first direction, the lens adjustment member 420 and at least a part of the elastic member 430 coupled to the lens adjustment member 420 may move in the first direction and thus be shape-deformed. For example, since the first portion 431 and the second portion 432 of the elastic member 430 are fixed, the third portion 433 coupled to the lens adjustment member 420 may be bent in the first direction. According to an embodiment, in case that the lens adjustment member 420 moves in the first direction, the lens adjustment member 420 may come into contact with a wheel 321 of the lens barrel 320.

Referring to FIG. 9C, in a state where the lens adjustment member 420 and the lens barrel 320 are in contact with each other, in case that a user rotates the lens adjustment member 420 in the first rotation direction (the clockwise direction or the counterclockwise direction), the wheel 321 of the lens barrel 320 may be rotated in a second rotation direction (the counterclockwise direction or the clockwise direction) opposite to the first rotation direction by being engaged with the lens adjustment member 420. In case that the wheel 321 rotates in the second rotation direction (the counterclockwise direction or the clockwise direction), the lens barrel 320 may rotate in the second rotation direction (the counterclockwise direction or to clockwise direction) to correspond to the movement direction of the wheel 321, and at the same time the positions of the lens barrel 320 and the lenses 310 may be adjusted to the front or the rear direction (e.g., the −Y-axis direction or the +Y-axis direction in FIG. 9C) so that the diopter of the lenses can be adjusted.

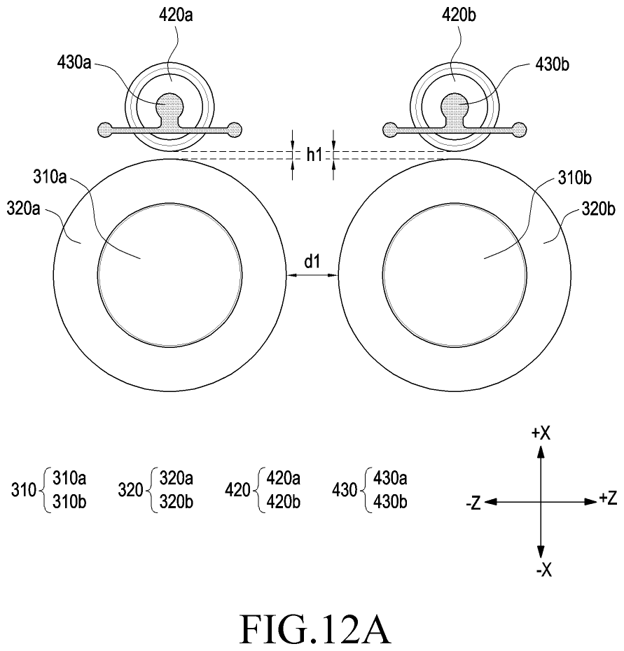

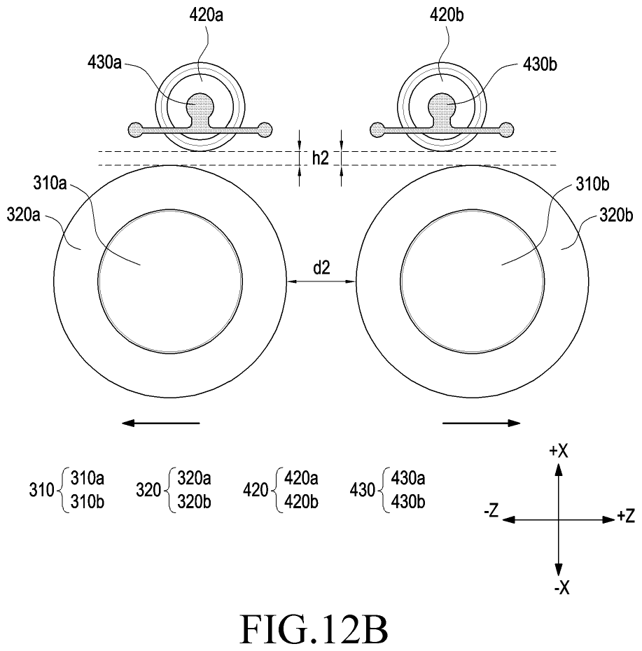

FIGS. 12A and 12B are views showing changes in the positions of a lens adjustment member 420 and an elastic member 430 according to the adjustment of distance between lenses according to various embodiments of the disclosure.

Referring to FIGS. 12A and 12B, a head-mounted display apparatus 300 may include a pair of lenses 310 and a pair of lens barrels 320, and a face cover 400 may include at least one lens adjustment member 420 and at least one elastic member 430. The configuration of the head-mounted display apparatus 300 and the face cover 400 in FIGS. 12A and 12B may be partially or entirely the same as the head-mounted display apparatus 300 and the face cover 400 in FIGS. 9A, 9B, 9C, 10A, 10B, and 11. The structure in FIGS. 12A and 12B may be selectively combined with the structure in FIGS. 9A, 9B, 9C, 10A, 10B, and 11.

Referring to FIG. 12A, the distance between a first lens barrel 320a and a second lens barrel 320b constituting the pair of lens barrels 320 may be a first inter-barrel distance d1. Referring to FIG. 12B, the pair of lenses 310 and the pair of lens barrels 320 may move in the left direction or the right direction to adjust the distance between the lenses. In case that a user wants to adjust the inter-pupillary distance (IPD), the lenses 310 may be moved in the left direction or the right direction, and thus an inter-barrel distance may be adjusted. According to the disclosure, even though the pair of lenses 310 and the pair of lens barrels 320 are moved in the left direction or the right direction according to the adjustment of the inter-pupillary distance (IPD), the diopter of the lenses may be adjusted by pressing and then rotating the lens adjustment member 420 by a user. For example, in case that the distance between the first lens barrel 320a and the second lens barrel 320b becomes a second inter-barrel distance d2 farther than the first inter-barrel distance d1 as a user adjusts the inter-pupillary distance (IPD), the distance between the lens adjustment member 420 and the lens barrel 320 may become farther (e.g., h2 in FIG. 12B). In this case, too, a user may adjust the diopter of the lenses by pressing the lens adjustment member 420 by distance h2 and then rotating same. For example, in case that the distance between the first lens barrel 320a and the second lens barrel 320b becomes a second inter-barrel distance (not shown) shorter than the first inter-barrel distance dl as a user adjusts the inter-pupillary distance (IPD), the distance between the lens adjustment member 420 and the lens barrel 320 may become farther (not shown). In this case, too, a user may adjust the diopter of the lenses by pressing and then rotating the lens adjustment member 420. According to the disclosure, a user can adjust the diopter of the lenses without being affected by the adjustment of the inter-pupillary distance (IPD).

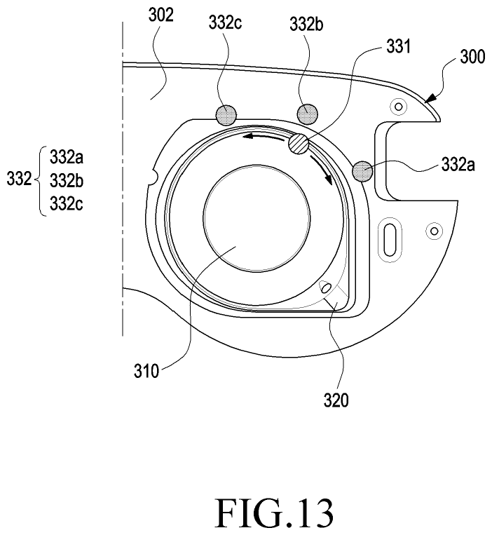

FIG. 13 is a view showing diopter sensing members according to an embodiment of the disclosure.

Referring to FIG. 13, a head-mounted display apparatus 300 may include a pair of lenses 310 and a pair of lens barrels 320. The configuration of the head-mounted display apparatus 300 in FIG. 13 may be partially or entirely the same as the configuration of the head-mounted display apparatus 300 in FIGS. 9A, 9B, 9C, 10A, 10B, 11, 12A, and 12B. The structure in FIG. 13 may be selectively combined with the structure in FIGS. 9A, 9B, 9C, 10A, 10B, 11, 12A, and 12B.

According to an embodiment, the head-mounted display apparatus 300 may be configured to sense the rotation of the lens barrels 320 and display the diopter value on the display so as to provide accurate information on the diopter to the user. According to an embodiment, a magnet 331 may be disposed inside each of the lens barrels 320. The magnet 331 may be disposed at an edge portion spaced apart from a rotation axis of each of the lens barrels 320. According to an embodiment, the magnet 331 may rotate in response to the rotation of the lens barrels 320. For example, in case that a user rotates the lens adjustment member 420 in the first rotation direction (the clockwise direction or the counterclockwise direction), wheel 321 of the lens barrels 320 and the lens barrels 320 may be engaged with the lens adjustment member 420 and thus be rotated in the second rotation direction (the counterclockwise direction or the clockwise direction). In case that the lens barrels 320 move in the second rotation direction (the counterclockwise direction or the clockwise direction), the magnet 331 coupled to each of the lens barrels 320 may also rotate in the second rotation direction (the counterclockwise direction or the clockwise direction) identically. According to an embodiment, multiple Hall effect ICs 332 for detecting a magnetic field may be arranged on a surface of a body part 302 of the head-mounted display apparatus 300. The multiple Hall effect ICs 332 may be arranged close to the magnet 331 disposed in each of the lens barrels 320. The multiple Hall effect ICs 332 may be arranged to be spaced a designated interval apart from each other. For example, the multiple Hall effect ICs may include a first Hall effect IC 332a disposed adjacent to a portion of a path along which the magnet 331 moves, a second Hall effect IC 332b spaced a predetermined interval apart from the first Hall effect IC 332a, and a third Hall effect IC 332c spaced a predetermined interval apart from the second Hall effect IC 332b. The rotation path and the motion of the magnet 331 may be detected through changes in the magnetic field detected by each of the multiple Hall effect ICs 332. For example, in case that the lens barrels 320 and the magnet 331 coupled to each of the lens barrels 320 rotate in the clockwise direction, the magnet may become away from the third Hall effect IC 332c and the second Hall effect IC 332b, and may become close to the first Hall effect IC 332a. For example, in case that the lens barrels 320 and the magnet 331 coupled to each of the lens barrels 320 rotate in the counterclockwise direction, the magnet may become away from the first Hall effect IC 332a and the second Hall effect IC 332b, and may become close to the third Hall effect IC 332c. Through the movement of the magnet 331 and the changes in the magnetic field detected by the multiple Hall effect ICs 332, information on the diopter of the lenses may be identified, be quantified, and then be provided to a user.

A face cover (400 FIG. 5A) according to an embodiment of the disclosure, which is detachably coupled to a head-mounted display apparatus (300 in FIG. 5A) that includes a lens (310 in FIG. 5A) and a lens barrel (320 in FIG. 5A) configured to surround the lens and adjust a position of the lens, may include a housing (410 in FIG. 5A) having an opening (411 in FIG. 5A) formed in an area thereof, a lens adjustment member (420 in FIG. 5A) disposed so that at least a portion thereof is exposed through the opening, and an elastic member (430 in FIG. 7) that includes opposite ends arranged in the housing and a central portion thereof coupled to the lens adjustment member, and is configured to provide an elastic force so as to allow the lens adjustment member to move in a first direction or in a second direction opposite to the first direction, wherein in case that an external force is applied to the lens adjustment member in the first direction, the lens adjustment member is configured to move in the first direction such that the lens adjustment member comes into contact with the lens barrel, and wherein in case that the lens adjustment member rotates in a first rotation direction in a state where the lens adjustment member and the lens barrel are in contact with each other, the lens barrel is configured to rotate in a second rotation direction opposite to the first rotation direction such that a diopter of the lens is adjusted.

According to an embodiment, in a state where the head-mounted display apparatus and the face cover are coupled to each other and the external force is not applied to the lens adjustment member in the first direction, the lens barrel and the lens adjustment member may be arranged to be spaced apart by a first distance (h1 in FIG. 9A).

According to an embodiment, wherein in a state where a distance between the lens barrel and another lens barrel of the head-mounted display apparatus is increased, the lens barrel and the lens adjustment member may be spaced apart by a second distance that is greater than the first distance.

According to an embodiment, the elastic member may include a first portion (431 in FIG. 8A) fixed to a first recess portion (412a in FIG. 9A) of the housing, which is adjacent to the opening, a second portion (432 in FIG. 8A) fixed to a second recess portion (412b in FIG. 9A) of the housing, which is adjacent to the opening, and a third portion (433 in FIG. 8A) between the first portion and the second portion, which is coupled to a central shaft of the lens adjustment member.

According to an embodiment, in case that the lens adjustment member moves in the first direction, the elastic member may be configured such that the third portion also moves in the first direction and at least a part of the elastic member is shape-deformed.

According to an embodiment, the lens adjustment member may include at least one of a wheel or a gear.

According to an embodiment, the elastic member may include at least one of a plate spring or a coil spring.

According to an embodiment, in case that the lens barrel rotates in the second rotation direction, lens may be configured to move in a front direction or a rear direction of the head-mounted display apparatus.

According to an embodiment, the head-mounted display apparatus may further include multiple first magnets, and the face cover may further include multiple second magnets corresponding to the multiple first magnets.

According to an embodiment, the elastic member may include a bar (531 in FIG. 8C) connected to a central shaft of the lens adjustment member, a first spring (532 in FIG. 8C) coupled to a first end of the bar, and a second spring (533 in FIG. 8C) coupled to a second end of the bar.

A head-mounted display apparatus according to an embodiment of the disclosure may include a lens, a lens barrel configured to surround the lens and be rotatable so as to adjust a position of the lens, and a body part detachably coupled to a face cover that includes a lens adjustment member configured to be in contact with a surface of the lens barrel, wherein based on the lens adjustment member of the face cover rotating in a first rotation direction, the lens barrel is configured to rotate in a second rotation direction opposite to the first rotation direction, and the lens is configured to move in a front direction or a rear direction of the head-mounted display apparatus.

According to an embodiment, the body part (302 in FIG. 13) may include multiple Hall effect ICs (332 in FIG. 13) arranged adjacent to the lens barrel and configured to detect a magnetic field, the lens barrel may include a magnet (331 in FIG. 13) attached to the inside of the lens barrel, and the multiple Hall effect ICs may be configured to detect information on the diopter of the lenses through changes in a magnetic field according to the rotation of the magnet, which corresponds to the rotation of the lens barrel.

According to an embodiment, the multiple Hall effect ICs may include a first Hall effect IC disposed adjacent to a portion of a path along which the magnet rotates, a second Hall effect IC spaced a predetermined interval apart from the first Hall effect IC, and a third Hall effect IC spaced a predetermined interval apart from the second Hall effect IC.

A face cover detachably coupled to a head-mounted display apparatus according to an embodiment of the disclosure may include a housing having an opening formed in an area thereof, a lens adjustment member disposed so that at least a portion thereof is exposed through the opening, and an elastic member that includes a central portion coupled to the lens adjustment member, and is configured to provide an elastic force so as to allow the lens adjustment member to move in a first direction or in a second direction opposite to the first direction, wherein in case that an external force is applied to the lens adjustment member in the first direction, the lens adjustment member is configured to move in the first direction, and wherein in case that the lens adjustment member rotates in a first rotation direction (the clockwise direction or the counterclockwise direction), the lens adjustment member is configured to adjust a diopter of a lens of the head-mounted display apparatus.

According to an embodiment, the head-mounted display apparatus may include the lens and a lens barrel configured to surround the lens and adjust a position of the lens.

According to an embodiment, in case that an external force is applied to the lens adjustment member in the first direction, the lens adjustment member may be configured to be moved in the first direction such that the lens adjustment member comes into contact with the lens barrel, and in case that the lens adjustment member rotates in a first rotation direction (the clockwise direction or the counterclockwise direction) in a state where the lens adjustment member and the lens barrel are in contact with each other, the lens barrel may be configured to rotate in a second rotation direction opposite to the first rotation direction and thus adjust the diopter of the lens.

According to an embodiment, in a state where the head-mounted display apparatus and the face cover are coupled to each other and the external force is not applied to the lens adjustment member in the first direction, the lens barrel and the lens adjustment member may be arranged to be spaced apart by a first distance h1.

According to an embodiment, in a state where a distance between the lens barrel and another lens barrel of the head-mounted display apparatus is increased, the lens barrel and the lens adjustment member may be spaced apart by a second distance that is greater than the first distance.

According to an embodiment, the elastic member may include a first portion (431 in FIG. 8A) fixed to a first recess portion (412a in FIG. 9A) of the housing, which is adjacent to the opening, a second portion (432 in FIG. 8A) fixed to a second recess portion (412b in FIG. 9A) of the housing, which is adjacent to the opening, and a third portion (433 in FIG. 8A) between the first portion and the second portion, which is coupled to a central shaft of the lens adjustment member.

According to an embodiment, in case that the lens adjustment member moves in the first direction, the elastic member may be configured such that the third portion also moves in the first direction and at least a part of the elastic member is shape-deformed.

According to an embodiment, the lens adjustment member may include at least one of a wheel or a gear.

According to an embodiment, the elastic member may include at least one of a plate spring or a coil spring.

A head-mounted display apparatus may be coupled to a blackout-type accessory (e.g., a face cover) for surrounding the space between the face of a user and the head-mounted display apparatus in order to maximize feeling of immersion of the user. In general, a head-mounted display apparatus for providing an eyesight correction function may include a barrel of a lens, and the barrel may be configured to rotate and thus adjust the diopter of the lens so as to be suitable to the eyesight of a user. In case that a face cover is used, the face cover may cover a barrel of a lens, and thus in case that a user adjusts the diopter of a lens, the user detaches the face cover therefrom and then wears the face cover again. Therefore, it may be inconvenient to use. In addition, in case that a head-mounted display apparatus includes a separate structure for adjusting the diopter thereof, the set weight and size may increase.

The face cover detachably coupled to the head-mounted display apparatus according to an embodiment of the disclosure may adjust the diopter thereof even in case that the face cover is used.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A face cover detachably coupled to a head-mounted display apparatus that includes a lens and a lens barrel configured to surround the lens and adjust positions of the lens, the face cover comprising:
a housing including an opening formed in an area thereof;
a lens adjustment member disposed in the opening so that at least a portion thereof is exposed through the opening; and
an elastic member that includes opposite ends arranged in the housing and a central portion thereof coupled to the lens adjustment member, and is configured to provide an elastic force so as to allow the lens adjustment member to move in a first direction or in a second direction opposite to the first direction,
wherein in case that an external force is applied to the lens adjustment member in the first direction, the lens adjustment member is configured to be moved in the first direction such that the lens adjustment member comes into contact with the lens barrel, and
wherein in case that the lens adjustment member rotates in a first rotation direction in a state where the lens adjustment member and the lens barrel are in contact with each other, the lens barrel is configured to rotate in a second rotation direction opposite to the first rotation direction such that a diopter of the lens is adjusted.

2. The face cover of claim 1, wherein in a state where the head-mounted display apparatus and the face cover are coupled to each other and the external force is not applied to the lens adjustment member in the first direction, the lens barrel and the lens adjustment member are arranged to be spaced apart by a first distance.

3. The face cover of claim 2, wherein in a state where a distance between the lens barrel and another lens barrel of the head-mounted display apparatus is increased, the lens barrel and the lens adjustment member are spaced apart by a second distance that is greater than the first distance.

4. The face cover of claim 1, wherein the elastic member includes:
a first portion fixed to a first recess portion of the housing, which is adjacent to the opening,
a second portion fixed to a second recess portion of the housing, which is adjacent to the opening, and
a third portion between the first portion and the second portion, which is coupled to a central shaft of the lens adjustment member.

5. The face cover of claim 4, wherein in case that the lens adjustment member moves in the first direction, the third portion of the elastic member is configured to move in the first direction and a shape of at least a part of the elastic member is configured to be deformed.

6. The face cover of claim 1, wherein the lens adjustment member includes at least one of a wheel or a gear.

7. The face cover of claim 1, wherein the elastic member includes at least one of a plate spring or a coil spring.

8. The face cover of claim 1, wherein in case that the lens adjustment member rotates in the first rotation direction, the lens is configured to move in a front direction or a rear direction of the head-mounted display apparatus.

9. The face cover of claim 1,
wherein the head-mounted display apparatus further includes multiple first magnets, and
wherein the face cover further comprises multiple second magnets corresponding to the multiple first magnets.

10. The face cover of claim 1, wherein the elastic member includes:
a bar connected to a central shaft of the lens adjustment member,
a first spring coupled to a first end of the bar, and
a second spring coupled to s second end of the bar.

11. A head-mounted display apparatus comprising:
a lens;
a lens barrel configured to surround the lens and be rotatable so as to adjust a position of the lens; and
a body part detachably coupled to a face cover that includes a lens adjustment member configured to be in contact with a surface of the lens barrel,
wherein based on the lens adjustment member of the face cover rotating in a first rotation direction, the lens barrel is configured to rotate in a second rotation direction opposite to the first rotation direction, and the lens is configured to move in a front direction or a rear direction of the head-mounted display apparatus.

12. The head-mounted display apparatus of claim 11,
wherein the body part includes multiple Hall effect integrated circuits (ICs) arranged adjacent to the lens barrel and configured to detect a magnetic field,
wherein the lens barrel includes a magnet attached to inside of the lens barrel, and
wherein the multiple Hall effect ICs are configured to detect information on a diopter of the lens through changes in a magnetic field according to a rotation of the magnet, which corresponds to the rotation of the lens barrel.

13. The head-mounted display apparatus of claim 12, wherein the multiple Hall effect ICs include:
a first Hall effect IC disposed adjacent to a portion of a path along which the magnet rotates,
a second Hall effect IC spaced a predetermined interval apart from the first Hall effect IC, and
a third Hall effect IC spaced a predetermined interval apart from the second Hall effect IC.

14. A face cover detachably coupled to a head-mounted display apparatus, the face cover comprising:
a housing including an opening formed in an area thereof;
a lens adjustment member disposed in the opening so that at least a portion thereof is exposed through the opening; and
an elastic member that includes a central portion thereof coupled to the lens adjustment member, and is configured to provide an elastic force so as to allow the lens adjustment member to move in a first direction or in a second direction opposite to the first direction,
wherein in case that an external force is applied to the lens adjustment member in the first direction, the lens adjustment member is configured to be moved in the first direction, and
wherein in case that the lens adjustment member rotates in a first rotation direction, the lens adjustment member is configured to adjust a diopter of a lens of the head-mounted display apparatus.

15. The face cover of claim 14, wherein the head-mounted display apparatus includes the lens and a lens barrel configured to surround the lens and adjust a position of the lens.

16. The face cover of claim 15,
wherein in case that an external force is applied to the lens adjustment member in the first direction, the lens adjustment member is configured to be moved in the first direction such that the lens adjustment member comes into contact with the lens barrel, and
wherein in case that the lens adjustment member rotates in a first rotation direction in a state where the lens adjustment member and the lens barrel are in contact with each other, the lens barrel is configured to rotate in a second rotation direction opposite to the first rotation direction such that the diopter of the lens is adjusted.

17. The face cover of claim 15, wherein in a state where the head-mounted display apparatus and the face cover are coupled to each other and the external force is not applied to the lens adjustment member in the first direction, the lens barrel and the lens adjustment member are arranged to be spaced apart by a first distance.

18. The face cover of claim 17, wherein in a state where a distance between the lens barrel and another lens barrel of the head-mounted display apparatus is increased, the lens barrel and the lens adjustment member are spaced apart by a second distance that is greater than the first distance.

19. The face cover of claim 14, wherein the elastic member includes:
a first portion fixed to a first recess portion of the housing, which is adjacent to the opening,
a second portion fixed to a second recess portion of the housing, which is adjacent to the opening, and
a third portion between the first portion and the second portion, which is coupled to a central shaft of the lens adjustment member.

20. The face cover of claim 19, wherein in case that the lens adjustment member moves in the first direction, the elastic member is configured such that the third portion also moves in the first direction and a shaped of at least a part of the elastic member is configured to be deformed.

21. The face cover of claim 14, wherein the lens adjustment member includes at least one of a wheel or a gear.

22. The face cover of claim 14, wherein the elastic member includes at least one of a plate spring or a coil spring.
